(19) United States
(12) Patent Application Publication
(10) Pub. No.: US 2025/0245139 A1
(43) Pub. Date: Jul. 31, 2025

(54) Method and System for Micro Front End Development and Testing Using Virtualization

(71) Applicant: Dell Products L.P., Round Rock, TX (US)

(72) Inventors: Mahesh Kumar Kancharla, Hyderabad (IN); Suraj Mohata, Bangalore (IN); Shibi Panikkar, Bangalore (IN); Yogesh Sinoriya, Gwalior (IN); Sandhya Rani Vemulapalli, San Antonio, TX (US)

(21) Appl. No.: 18/428,895

(22) Filed: Jan. 31, 2024

(51) Int. Cl. G06F 11/36

(52) U.S. Cl. CPC G06F 11/3698

(57) ABSTRACT

Described herein are methods and a system for virtualization of micro front ends (MFE). In a development environment, a virtual container shell is provided to load, create, and test virtual MFEs. A virtualized domain MFE is created in the virtual container shell. The virtualized domain MFE is used for the development and testing of a an “real” or actual MFE for end user or customer use. One or more virtualized inline MFEs for use with the virtualized domain MFE, where downward and loopback dependency is provided between the virtualized inline MFEs and virtualized domain MFE, allowing for data to be received and sent.

### BACKGROUND OF THE INVENTION

### Field of the Invention

The present invention relates to providing virtualized micro front ends (MFE) to be used in the development and testing of dependent MFEs. More specifically, providing inline and dependent virtualized MFEs to be used in developing and testing domain MFEs.

### Description of the Related Art

Businesses and use of information continues to increase, individuals and businesses seek additional ways to process and store information. One option available to users are information handling systems or IHS. An IHS generally processes, compiles, stores, or communicates information or data for business, personal, or other purposes thereby allowing users to take advantage of the value of the information. Variations in IHSs allow for information handling systems to be general or configured for a specific user or specific use such as transaction processing, airline reservations, enterprise data storage, or global communications. In addition, an IHS can include a variety of hardware and software components that can be configured to process, store, and communicate information and may include one or more computer systems, data storage systems, and networking systems. Further, an IHS can be incorporated in a variety of environments, including, for example, desktop devices, mobile devices, and large data center configurations with hundreds-to-thousands of information handling systems in multiple environments.

A growing trend is the use of micro front ends or MFEs with IHSs. An MFE extends services (i.e., micro services) to the frontend or interface on an IHS. An MFE can include a feature rich browser application that sits on top of a micro service architecture. An MFE can be liken to a website or web application that provides a composition of features. An MFE can be developed and supported by independent teams or domains with each team/domain having a specific business or operational mission, and provide customer (end user) facing applications. Through an MFE, customers are given an end to end experience. A team/domain can be cross functional and develop features of the MFE end to end, including storage (e.g., database) and user interfaces.

The use of MFEs can offer great flexibility and allow independent ownership of teams/domains leading to increased time to market and reusability; however, challenges exist in development and testing. Such challenges can be due to the reliance of teams/domains upon other MFEs, such as those used in various systems/subsystems. MFEs may operate as independent user interfaces relying on a “shell” environment and rely on other MFEs to provide specific functionality. For example, a subscription MFE may depend on a licensing MFE for licensing information to create subscription.

Dependencies can result in teams/domains waiting for other teams/domains to complete their respective MFEs or for an MFE container to be available for testing. Coordinating timing and availability of different MFEs and ensuring their smooth integration within the overall system can pose additional challenges. Planning and coordination between teams/domains, such as creating mock shells (can require multiple versions of shells) or skeleton MFEs can allow for testing of MFEs; however, can place additional workload on teams/domains and aligning timelines across the teams/domains. As a consequence, development and testing processes can become more complex and time-consuming.

### SUMMARY OF THE INVENTION

A computer-implementable method, system and computer-readable storage medium for micro front end (MFE) virtualization comprising providing a virtual container shell to load and create virtual MFEs; providing a virtualized domain MFE in the virtual container shell, for developing and testing an MFE for customer use; and creating one or more virtualized inline MFEs for use with the virtualized domain MFE, wherein downward and loopback dependency is provided between the virtualized inline MFEs and virtualized domain MFE.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 is a system as implemented in the present invention;

FIG. 3 is a webpage represented as a container;

FIG. 4 is virtual container;

FIG. 5 is a template of a virtualized micro front end (MFE) container;

FIG. 6 is a filled virtualized micro front end (MFE) container;

FIG. 7 is a digital fulfillment micro front end or DF MFE;

FIG. 8 is an architecture implementing a micro front end (MFE) shell virtualization;

FIG. 9 is an architecture/system for creation and selection of images;

FIG. 10 is an architecture for manually implementing depending micro front ends (MFE); and

FIG. 11 is a generalized flowchart for micro front end (MFE) virtualization.

### DETAILED DESCRIPTION

Implementations described herein provides for micro front end (MFE) virtualization. Teams/domains (developers) create a virtualized container shell and virtualized dependent MFEs to be used in development and testing of MFEs without relying on other teams/domains. The virtualized container shell is loaded and created automatically using manual or automated processes (e.g., artificial intelligence or AI generated). Inline MFEs are created for use by a MFE domain/team for development and testing and upward dependency. Dependent MFE are created for use by the MFE domain/team for development and testing and downward dependency.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

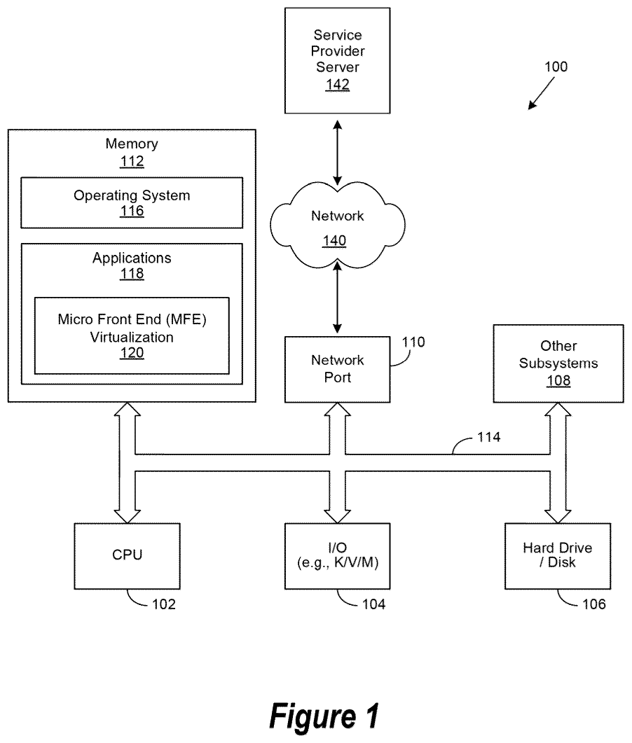

FIG. 1 is a generalized illustration of an information handling system (IHS) 100 that can be used to implement the system and method of the present invention. The information handing system (IHS) 100 can be a host to the peripheral devices described herein.

The information handling system (IHS) 100 includes a processor (e.g., central processor unit or “CPU”) 102, input/output (I/O) devices 104, such as a microphone, a keyboard, a video display or display device, a mouse, and associated controllers (e.g., K/V/M), a hard drive or disk storage 106, and various other subsystems 108.

In various embodiments, the information handling system (IHS) 100 also includes network port 110 operable to connect to a network 140, where network 140 can include one or more wired and wireless networks, including the Internet. Network 140 is likewise accessible by a service provider server 142.

The information handling system (IHS) 100 likewise includes system memory 112, which is interconnected to the foregoing via one or more buses 114. System memory 112 can be implemented as hardware, firmware, software, or a combination of such. System memory 112 further includes an operating system (OS) 116 and applications 118. Implementations provide for applications 118 to include a micro front end (MFE) virtualization engine 120. The MFE virtualization engine 120 is used to provide simulated end-to-end end user experience during development and testing, even if MFEs have not be completed or available.

Implementations provide for three types of MFE virtualization, including 1) MFE shell virtualization (virtual MFE shell or V-MFE-S) that allows MFE teams/domains to create a virtualized MFE environment to orchestrate and test their MFEs; 2) Inline MFE virtualization (virtual MFE inline or V-MFE-I) that allows MFE teams/domains to create a virtual input to their MFE from a virtualized MFE shell during development and testing; and 3) dependent MFE virtualization (virtual MFE dependent or V-MFE-D) that allows MFE teams/domains to create a virtual MFE that mimics end user experience and data flow and data flow between their MFE and dependent MFEs.

Applications 118 can include other applications as described herein that are used by or operate independent of the MFE virtualization engine 120. It is to be understood that in various implementations, one or more IHS may be used, and may be implemented as part of a cloud computing environment.

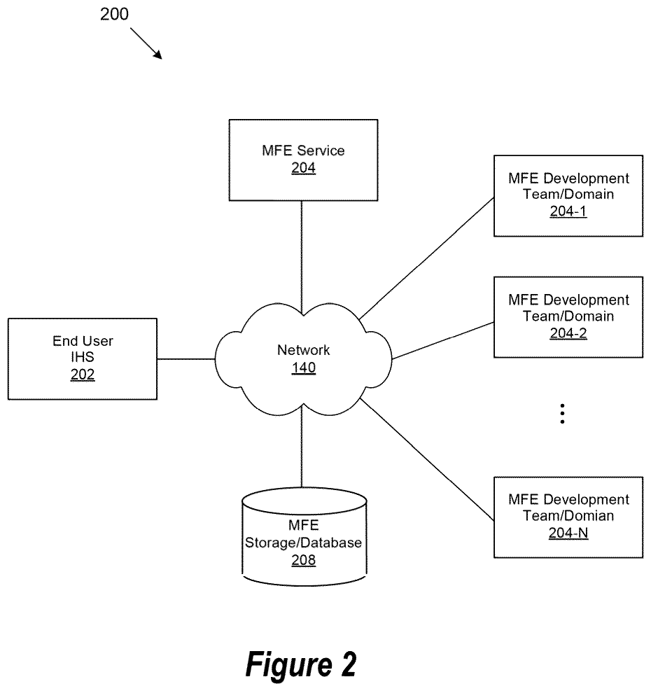

FIG. 2 shows a system 200 that supports the processes described herein. Implementations provide for an end user IHS 202. An MFE service 204 provides MFEs to the end user IHS 202. MFE service 204 may be implemented as a website/service and connected to the end user IHS 202 by network 140. The MFE service 204 can include micro services that provide data; however, MFEs provided that include how the data is presented (e.g., presentation layer). Capability of a particular website may be provided through the MFE service 204, and can include input details, navigational details, information output, containers holding content, etc. Particular user interfaces (UI) can be provided through the MFEs, wherein the UIs are part of the website.

An example that MFE service 204 provides to end user IHS 202 is a customer/user experience or webpage/website related to an account of the customer user. The system 200 further can include multiple MFE development teams/domains 204-1 to 204-N. Each MFE development team/domain 204 can include multiple IHS, or computing devices, configured to create, develop, and test MFEs. In particular, the MFE development teams/domains 204-1 to 204-N generate actual and virtualized MFEs. Virtualized MFEs can be created using the MFE virtualization engine 120 described in FIG. 1.

The MFE development teams/domains 204-1 to 204-N can operate independent of one another. In certain implementations, the MFE development teams/domains 204-1 to 204-N rely on particular MFEs of other MFE development teams/domains 204-1 to 204-N.

Examples of MFE development teams/domains 204-1 to 204-N include the following. A customer/user account MFE development team/domain 204 is provided for customer/user accounts, and implements other MFEs, such as the following MFEs. A customer/user subscription MFE development team/domain 204 creates a subscription for customers/users. A customer/user license or digital fulfillment MFE development team/domain 204 generates licenses for customer/user subscriptions for customer/user site(s). A customer/user ID MFE development team/domain 204 is used to accept tenant ID and domain ID of customers/users, used for verification and provided to subscription MFEs.

In various implementations, the system 200 includes an MFE storage/database 208, where actual and virtualized MFEs of the MFE development teams/domains 204-1 to 204-N can be stored. The MFEs in MFE storage/database 208 can be accessed and used by the MFE development teams/domains 204-1 to 204-N.

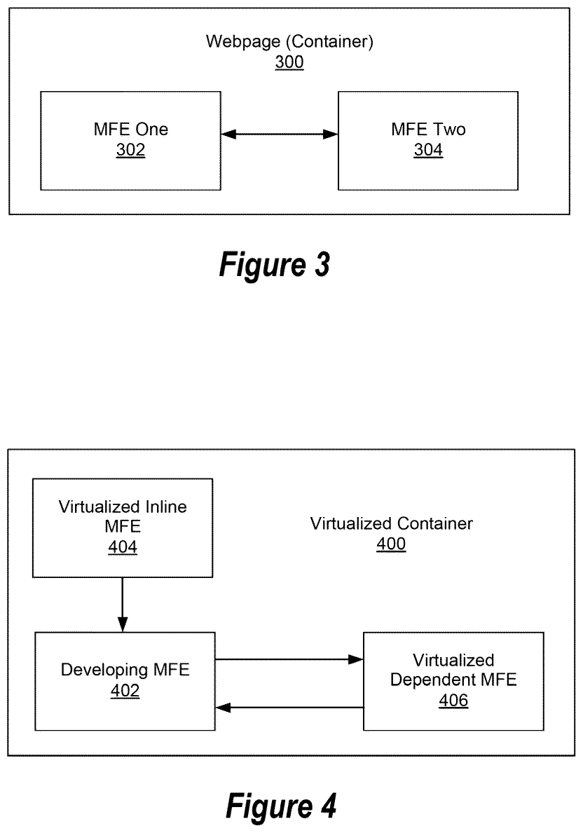

FIG. 3 shows a webpage represented as a container. Webpage 300 is provided as a container. The webpage 300 is presented to an end user (e.g., end user IHS 202, or developers of MFEs (e.g., MFE development team/domain 204). As discussed, a website can be provided through MFE service 204.

The webpage 300 includes user interfaces (UI) through MFEs as discussed above. The webpage 300 can be developed as a container and as an MFE by a particular MFE development team/domain 204. Within the webpage (container) 300 are multiple MFEs that interact with one another, as represented by MFE One 302 and MFE Two 304.

As discussed, separate and independent MFE development teams/domains 204 can create, develop, test different MFEs, such as MFE One 302 and MFE Two 304. Furthermore, webpage (container) 300 can be an MFE that is created, developed, and tested by a particular MFE development team/domain 204.

For example, the webpage (container) 300 can be a customer/user account MFE. MFE One 302 can be a customer/user subscription MFE. MFE Two 304 can be a license or digital fulfillment MFE. Each of the MFEs, i.e., webpage (container) 300, MFE One 302, and MFE Two 304 rely on another for certain inputs and outputs. Since the MFEs are created, developed, and tested by different MFE development teams/domains 204, MFEs may not be available to other MFEs for use. Therefore, the use of a virtualized MFEs can be used by a MFE development team/domain 204, avoiding the need to implement MFEs from other MFE development teams/domains 204.

FIG. 4 shows virtual container. Virtualized container 400 is considered as virtual shell MFE, and provides calls/inputs to a developing MFE 402 through virtualized inline MFE 404. Virtualized inline MFE 404 allows for entering inputs/calling the developing MFE 402.

As discussed, for example virtualized container 400 can be customer/user account MFE. The developing MFE 402 can be a customer/user subscription MFE. By the use of virtualized MFEs, the developing MFE 402 (i.e., MFE development team/domain 204 supporting the developing MFE 402), can perform independent functional testing without available MFEs from other MFE development teams/domains 204.

A virtualized dependent MFE 406 receives and sends input to the developing MFE 402, such as particular calls and values. The virtualized dependent MFE 406 imitates an actual MFE that developing MFE 402 uses. As an example, the dependent MFE 406 imitates an actual license or digital fulfillment MFE, and allows the developing MFE 402 (i.e., customer/user subscription MFE) to generate a license. For example, the developing MFE 402 (i.e., customer/user subscription MFE) passes IDs to the dependent MFE 406 (i.e., license or digital fulfillment MFE) and receive s back a “license.”

As discussed, implementations provide for MFE virtualization using a shell MFE virtualization as shown for example as virtualized container 400; an inline MFE virtualization as shown for example as virtualized inline MFE 404; and a dependent MFE virtualization.

Implementations provide for a MFE development team/domain 204 to create such virtualized MFEs when developing their MFEs. For example, development and testing of developing MFE 402. The MFE development team/domain 204 can use the MFE virtualization engine 120 described in FIG. 1 to create the virtualized MFEs. In certain implementations, a user interface (UI) is presented to allow creation of the virtualized MFEs.

The shell MFE virtualization is a virtualized shell that is created by and allows a MFE development team/domain 204 to create and develop their MFEs (i.e., developing MFE) and virtualized MFEs (i.e., inline MFE and dependent MFE).

The virtualized shell can be designated as “Virtualized Micro frontend Shell” (V-MFE-S). In certain implementations, a MFE development team/domain 204 is presented with options as to technology and templates to create the V-MFE-S. For example, a UI can include a header pane with the following: an icon to Add existing MFE to view (also used to add real MFE); icon to create new virtualized MFEs; icon to remove MFEs; icon to edit virtualized MFEs; a view as to the added MFEs in icon or tabs (virtualized and real MFEs); controls for self-loading dependent MFEs.

For example, the UI can include a body pane with a placeholder where an MFE will be loaded. The UI can include an operation pane that adds details of new virtualized MFE or edit existing virtualized MFE. MFEs that are added, created, removed, or edited can be stored in MFE storage/database 208 described in FIG. 2.

In an example implementation, MFE development team/domain 204 that provides for a developing MFE 402 (e.g., customer/user subscription MFE) creates details of the page of the developing MFE 402 (e.g., details of the customer/user subscription MFE). The MFE development team/domain 204 creates a container virtualized MFE (CVMFE). The CVMFE is the virtualized MFE for the MFE development team/domain 204 that provides the following example inputs: team name (e.g., subscription), application name (e.g., SUB), layout (e.g., header: top, body: center, operation: right), etc.

In an implementation, when a MFE development team/domain 204, a UI of the MFE virtualization engine 120, allows creation of the CVMFE (e.g., click on icon “Create CVMFE). A virtual instance of the CVMFE is created for the development team/domain 204 (e.g., subscription or SUB team).

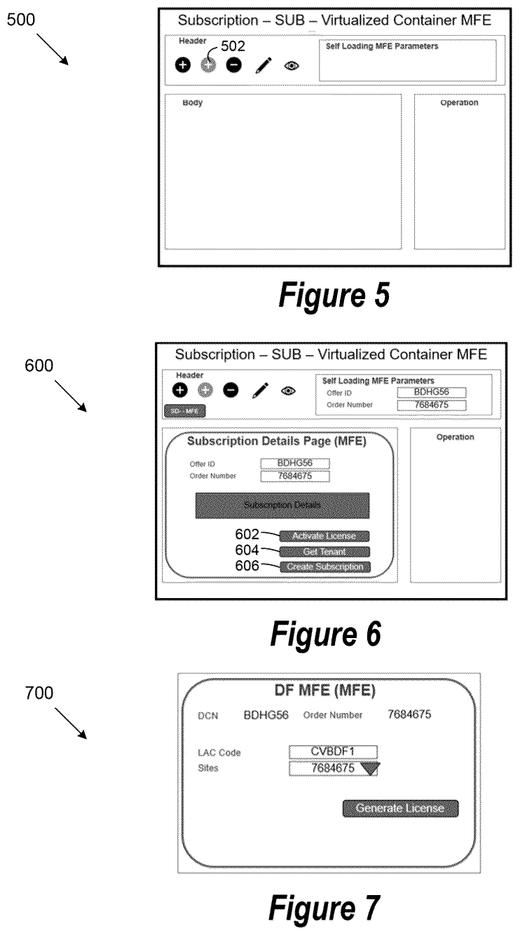

FIG. 5 shows a template of a virtualized MFE container. The MFE development team/domain 204 can open the virtualized MFE container 500, and can begin developing their MFE (e.g. subscription details MFE). The MFE may need inputs, for example “OfferID,” “QuoteID” to show the page. In certain implementations, such inputs can be provided from a catalog/store, and can be self loading, but activating (clicking) icon 502.

Dependent virtualized MFEs can be configured per Table 1 below.

TABLE 1

| | | | | Suggested |
|---|---|---|---|---|
| Direction | Description | Data Type | Nature of Values | Control |
| Self | Offer ID | Text | Single Value | TextBox |
| Self | Order Number | Number | Single Value | TextBox |

Callback endpoints may be obtained from a particular URL (e.g., https://myserver/SubscriptionDetails).

Once inputs are submitted, they are deployed in virtualized MFE container. FIG. 6 shows a filled virtualized MFE container 600. “Controls” appear in the “Self-Loading MFE Parameters.” The MFE development team/domain 204 can enter any “Offer ID and Order Number” and load the “Subscription Details MFE” in the virtualized MFE container 600. In such an implementation, there is no need to depend on the catalog/store to begin developing the developing MFE 402 (e.g., customer/user subscription MFE). The developing MFE 402 can be started without any dependency.

The following uses the example of MFE development teams/domains 204 described above that include a customer/user account MFE development team/domain 204, a customer/user subscription MFE development team/domain 204, a customer/user license or digital fulfillment MFE development team/domain 204 and a customer/user ID MFE development team/domain 204.

The MFE container 600 has a button “Activate License” 602 that calls the digital fulfillment MFE or DF MFE to activate a license for an order. The button “Get Tenant” 604 calls customer/user ID MFE or Customer MFE, to capture a Tenant ID and Domain ID from an end user/customer, which are verified. Once the information is received, the “Create Subscription” button 606 creates a subscription.

Since the actual DF MFE and actual Customer MFE may not be ready for integration since they are also being developed, they cannot be used. Dependent virtualized MFEs can be used for the actual DF MFE and actual Customer MFE.

Inputs to be sent and received (passed) from the DF MFE and actual Customer MFE are to be determined and provided. For example, for “Activate License” 602, the DF MFE needs a “Customer ID” and “Order Number”. An example process for the DF MFE can be the following: 1) DF MFE will accept LAC Code and Customer Location, 2) DF MFE activates the license for the customer site, 3) DF MFE returns a License Key, a Letter Activation Code, and Customer Sites to Create Subscription. For 2) and 3) in particular, business functions (e.g. licensing business processes) are performed. When a virtualized dependent MFE is implemented, such business functions are not important. Business functions (e.g. licensing business processes) occur for digital fulfillment and generation of license, and activation for customer locations; however, the virtual dependent MFE just imitates input and output with end user/customer entering values.

FIG. 7 shows a representation of a digital fulfillment or DF MFE. In particular, a dependent virtualized MFE is represented by DF MFE 700. MFE development teams/domains 204 are able to use the virtualized container 400 to add a new virtual MFE, for example configure the virtual MFE as a “Licensing Virtual MFE”. Such a Licensing Virtual MFE can include the configurations of Table 2 below.

TABLE 2

| | | | Nature of | Suggested | Default |
|---|---|---|---|---|---|
| Direction | Description | Data Type | Values | Control | Value |
| Target MFE | Dell Customer | Number | Single Value | Label | $Value |
| Call | Identification | | | | |
| | Number | | | | |
| Target MFE | Order Number | Number | Single Value | Label | $Value |
| Call | | | | | |
| Call Back | License Key | String | Single Value | Text Box | Random |
| | | | | | (24 Alpha |
| | | | | | Numeric) |
| Call back | License | String | String Value | Text Box | Manual |
| | Activation | | | | |
| | Code | | | | |
| Call back | Customer | List | Multiple | Multi-Select | Manual |
| | Locations | (Assuming | (Bangalore, | Combo box | |
| | | pre-defined | Delhi, Bombay, | | |
| | | values) | Chennai) | | |

The MFE virtualization engine 120 can use the template described in FIG. 5 and the configurations of Table 2 to create an MFE image used in continuous integration/continuous development (CI/CD) to be deployed as a dependent virtualized MFE.

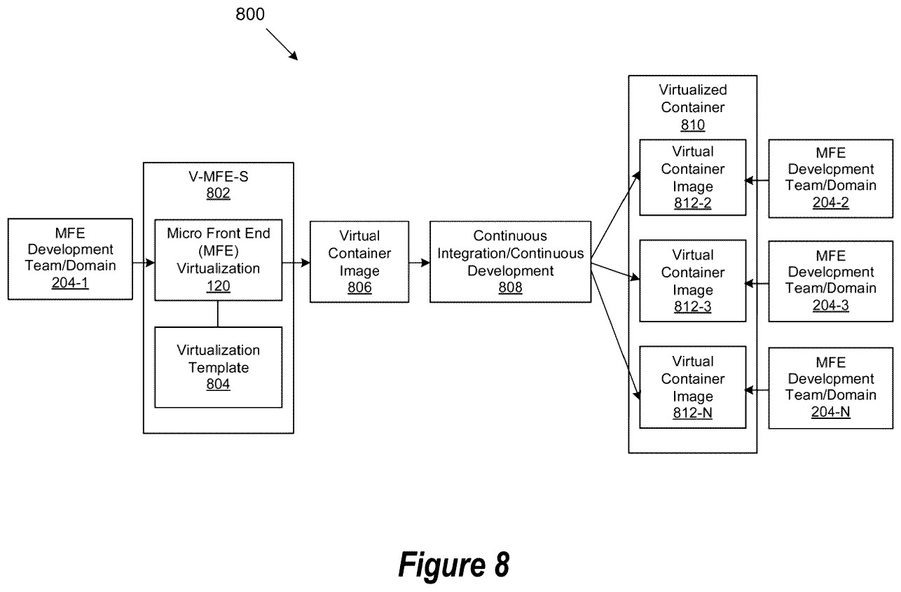

FIG. 8 shows a high level architecture that implements a MFE shell virtualization (virtual MFE shell or V-MFE-S). The architecture or system 800 provides for an MFE development team/domain 204-1 to create virtualized MFEs as described above, including a V-MFE-S 802. In particular, the V-MFE-S 802 is created using the MFE virtualization engine 120 described in FIG. 1 and a virtualization template 804. to create the virtualized MFEs.

The MFE virtualization engine 120 is provided with URLs, payloads, content, etc. by the MFE development team/domain 204-1. The virtualization template 804 is associated with a virtual container. A virtual container image 806 is created and provided to a continuous integration/continuous development (CI/CD) 808. CI/CD 808 creates a specific container to deploy the V-MFE-S 802. The virtual container image 806 can be stored in virtual container store 810. In certain implementations the virtual container store 810 can be or be part of MFE storage/database 208 described FIG. 2. Other virtual image containers 812-2 to 812-N can be stored in virtual container store 810. virtual image containers 812-2 to 812-N are created and provided by respective MFE development teams/domains 204-2 to 204-N.

The following describes how an image (i.e., virtual container image) can be created and selected. In certain implementations, MFE virtualization engine 120 or another application can be used by a MFE development team/domain 204.

A virtualized shell image or virtual container image can be created using various languages/libraries, for example “react” or “react.js”. React is an open-source front-end JavaScript library for building user interfaces based on components.

An MFE shell project is created using react. A shell MFE is created based on a default template. An example of a default template is based on the following template (code).

```
import React, { useState } from ‘react’; 6.9k (gzipped: 2.7k)
import ‘./App.css';
function App( ) {
  const [showRightPane, setShowRightPane] = useState(false);
  return (
    <div className=“app-container”>
    | <header classname=“header”> Header Pane - Menu and Inline MFE Controls loads here</header>
    | <div className=“body”>Body - Tesitng MFE Loads here</div>
    | {showRightPane && <div className=“right-pane”>Operational Pane - Manage the MFE behavior</div>}
    | <button onClick={( ) => setShowRightPane(|showRightPane)}>
    | Toggle Right Pane
    | </button>
    </div>
  );
}
export default App;
```

The layout can be changed by changing parameters in the above template. A virtual environment can be created using a platform such a “Docker.” A Docker build is created (i.e., MFE shell image). MFE development teams/domains 204 can create multiple images based on the particular layout requirements. The images can be stored in an image registry with image identifiers (IDs). Also stored in the image registry can be input by MFE development teams/domains 204 and the image IDs.

Images can be pushed to a CI/CD platform (e.g., CI/CD 808), such as Kubernetes, to testing namespace to deploy the virtual MFE for testing. As MFE development teams/domains 204 grows the number of images and deployments, it may be more efficient to re-use MFE shells across MFE development teams/domains 204. Use of traditional database store and search techniques may not be best. Therefore, implementation of artificial intelligence (AI) methods can be used, such as a large language model (LLM). A large language model (LLM) is a type of AI program that can recognize and generate text, among other tasks. LLMs can be trained on relatively large sets of data. LLMs are built on machine learning, and in specific a type of neural network called a transformer model.

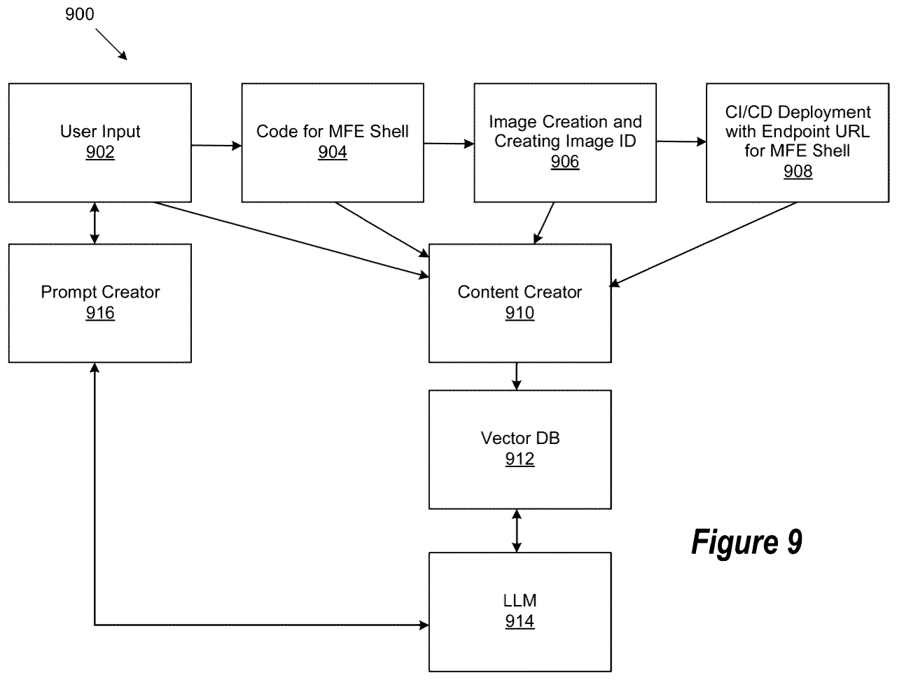

FIG. 9 shows an architecture or system 900 for creation and selection of images (i.e., virtual container image). A user input 902 is provided. User (i.e., MFE development team/domains 204) inputs vary for a specific MFE shell layout, image ID, and endpoint URL for an MFE shell.

The user input 902 is directed to code for MFE shell 904 which provides input to image creation and creating image ID 906. Image creation and creating image ID 906 to CI/CD deployment with endpoint URL for MFE shell 908. User input 902, code for MFE shell 904, image creation and creating image ID 906, and CI/CD deployment with endpoint URL for MFE shell 908 provide input to content creator 910. Content creator 910 provides vectors to a vector DB 912. The vector DB 912 communicates with an LLM 914. User input communicates with a prompt 916.

In various implementations, using an LLM, a vector search can be used to determine an end point URL of an image. The following can be implanted. A MFE development team/domains 204 provides an input (i.e., user input 902), which can vary, for a specific MFE shell layout, image ID and end point URL of the MFE shell. Context can be created and embedded in an LLM and stored in a vector database using an automated tool. A prompt is created (i.e., prompt creator 916) to get a URL for the “new” user input, such as when a user enters input for creating a new MFE, rather than creating code. A check can be performed to determine if a created image exists and if the URL is present.

A call is performed to the LLM 914 with a prompt to get the mage and URL (e.g., temperature=0, prompt: “Use the Embedded Context. Please give me any URL that matches the user input”).

An example of context creator output is the following:

```
“Below are the details of the MFE Code Deployment
User input is: Create MFE Shell with
  1) 4 pane layout
  2) Controls at the top
  3) MFE needs to be loaded middle
  4) Operation Pane at Right
Code for the MFE is
“Code Goes here”
The Image name for this MFE Shell is “ImageID1”
The Deployment URL for this “https://someserver.com/endpoint
```

The above context can be embedded in vector DB 912. A prompt (i.e., prompt creator) can be used to get the URL of the image. The following is an example:

Use the Context Given
User Input is <User Input>
Please give me the Deployment URL if present, and also give me the code
for verifying.

In various implementations, with use and training, LLM 914 can generate new layout code for new layouts.

As discussed above, implementations provide for three types of MFE virtualization, including 1) MFE shell virtualization (virtual MFE shell or V-MFE-S) that allows MFE teams/domains to create a virtualized MFE environment to orchestrate and test their MFEs; 2) Inline MFE virtualization (virtual MFE inline or V-MFE-I) that allows MFE teams/domains to create a virtual input to their MFE from a virtualized MFE shell during development and testing; and 3) dependent MFE virtualization (virtual MFE dependent or V-MFE-D) that allows MFE teams/domains to create a virtual MFE that mimics end user experience and data flow and data flow between their MFE and dependent MFEs.

Dependent MFE virtualization is used to provide a virtualized MFE for development and testing of real MFE, and can be created inside of V-MFE-S. A virtualized dynamic MFE will does not need to know about actual implementation of business logic as a real MFE, but can provides the necessary experience and data to test the developing MFE.

Two types of dependent MFE virtualization can be defined: inline virtualized MFE and standalone virtualized MFE. For inline virtualized MFEs, an actual MFE is not created. The necessary “controls” are created for loading the necessary real MFE and can be displayed in a virtualized MFE shell. This is useful for testing an MFE which is dependent on another MFE or expecting parameters from the MFE shell. Standalone virtualized MFEs are created and deployed, and can operate as independent MFEs. A standalone virtualized MFEs will have all controls for customer interaction, but does not need to implement business logic. The parameters for a “real MFE” are used and all controls shown as in the real MFE, providing a proper experience. Upon a “submit”, a standalone virtualized MFE can call back or call out, depending on the implementation, to the original MFE.

Implementations provide for dependent MFE virtualization to be created by automatically generating and picking an appropriate template based on a called endpoint URL and call back URL, and parameters using natural language processing (NLP), intent derivation and a knowledge base. Dependent MFE virtualization can be created through manual configuration of component and template selection.

For automatic generation of dependent MFE virtualization, endpoint URLs are read for a targeted MFE and a call back URL. Parameters are entered in natural text format. NLP read the next inputs and derive intent and expected control. A user (e.g., MFE development team/domain 204) is prompted to enter endpoint URL for targeted MFE and call back URL with the parameter expected. Parameters can be designated by “curly bracket” and in natural language.

For example, in the scenario described above, subscription MFE development team/domain 204 is developing a “Subscription MFE” and has dependency on DF MFE. When “Activate License” is clicked, the Subscription MFE needs to call DF MFE by passing customer number or CN. In the call back to the Subscription MFE from the DF MFE, the DF MFE expects a license key, LAC code, customer site locations, etc. for which the license is to be activated.

The user (e.g., MFE development team/domain 204) can provide a targeted MFE relative endpoint. For example,/ActivateLicense with targeted MFE Parameters: customer identification number. No Need to show in the Targeted MFE (In natural English). Callback URL:/SubscriptionDetails (MFE that is getting developed). Callback Parameters: License Key, LAC Code, Customer Site Locations that those licenses are activated.

Implementations provide to substring each parameter and derive data type using LLM (e.g., LLM 914). Furthermore, if the LLM detects plural locations, the LLM can inquire if as to needed defined values, generated values, or customer that is entered.

With each derived data type, a “suitable control” can be derived from a knowledge base (e.g., pre-created mapping). If selected as “pre-determined”, the “list” to enter the values is shown. The values can be stored in the configuration data store. The following example configuration data table 3 can be derived.

TABLE 3

| | | | | | |
|---|---|---|---|---|---|
| | | | Nature of | Suggested | Default |
| Direction | Description | Data Type | Values | Control | Value |

| | | | | |
|---|---|---|---|---|
| Target MFE | Dell Customer | Number | Single Value | Label |
| Call | Identification | | | |
| | Number | | | |
| Call Back | License Key | String | Single Value | Text Box |
| Call back | License | String | String Value | Text Box |
| | Activation | | | |
| | Code | | | |
| Call back | Customer | List | Multiple | Multi-Select |
| | | (Assuming | (Bangalore, | |
| | | pre-defined | Delhi, | |
| | Locations | values) | Bombay, | Combo box |
| | | | Chennai) | |

Implementations provide for the MFE virtualization engine 120 to use the configuration data and template to create a dependent MFE image. The dependent MFE image is provided to CI/CD. CI/CD generates a container, and the container is provided for MFE deployment. Each virtualized dependent MFE has a unique number generated (e.g., DVMFE_ID). The unique number (e.g., DVMFE_ID) can be referenced to by container virtualized MFE (CVMFE) container to view the virtual MFE in a header.

The values under “Direction” can be used by the MFE virtualization engine 120 to generate a type of MFE. A targeted MFE creates new virtual MFE with a new endpoint. A call back is directed to controls to be created on the new MFEs. Parameters are passed from the virtual MFE to developing (Real) MFE. A self is directed to creating inline controls in a virtualized MFE shell to load an MFE. The following table 4 is an example.

TABLE 4

| | | | | Suggested |
|---|---|---|---|---|
| Direction | Description | Data Type | Nature of Values | Control |
| Self | Order Number | Text | Single Value | TextBox |

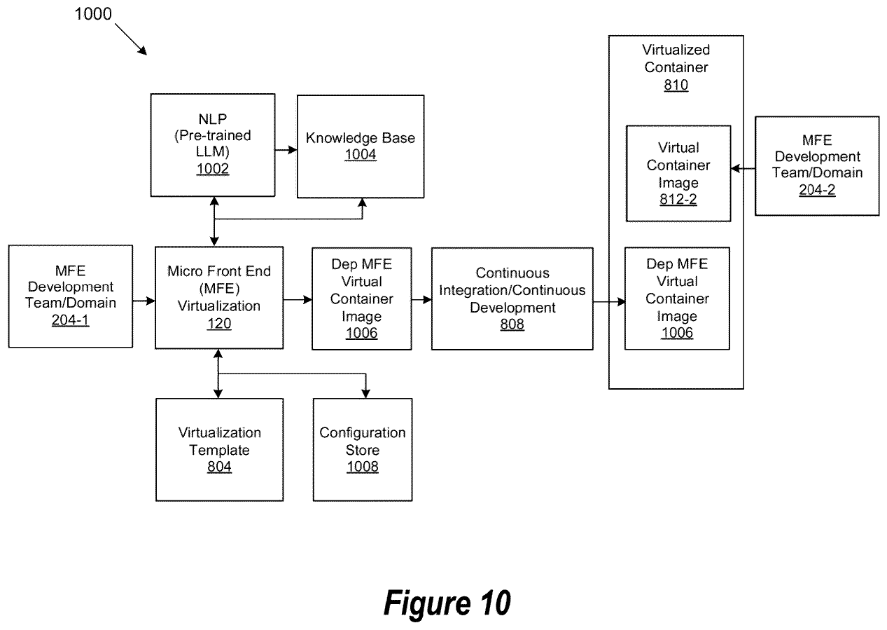

In certain implementations, table 3 for dependent MFEs is created manually by users (i.e., MFE development team/domain 204). FIG. 10 shows an architecture for manually implementing depending micro front ends (MFE). The architecture 1000 provides for an NLP Pre-trained LLM 1002 and a knowledge base 1004. MFE development team/domain 204-1 creates dependent virtual MFE container image(s) 1006. In particular, the dependent virtual MFE container image(s) 1006 are created using the MFE virtualization engine 120 described in FIG. 1 and a virtualization template 804. to create the virtualized MFEs.

The architecture 1000 further can include a configuration store 1008 that connects with the MFE virtualization engine 120 and virtualization template 804 for storing configuration data (i.e., configuration data table 3). The dependent virtual MFE container image(s) 1006 are provided to continuous integration/continuous development (CI/CD) 808. The dependent virtual MFE container image(s) 1006 can be stored in virtual container store 810. In certain implementations the virtual container store 810 can be or be part of MFE storage/database 208 described FIG. 2. Other virtual image containers, such as 812-2 can be stored in virtual container store 810, where virtual image containers 812-2 is created and provided by MFE development teams/domains 204-2.

Referring back to FIG. 3, an example implementation describes that an example, where the webpage (container) 300 can be a customer/user account MFE. MFE One 302 can be a customer/user subscription MFE. MFE Two 304 can be a license or digital fulfillment MFE. Each of the MFEs, i.e., webpage (container) 300, MFE One 302, and MFE Two 304 rely on another for certain inputs and outputs. Since the MFEs are created, developed, and tested by different MFE development teams/domains 204, MFEs may not be available to other MFEs for use. Therefore, a virtualized MFEs can be used by a MFE development team/domain 204, avoiding the need to implement MFEs from other MFE development teams/domains 204.

In particular, in this example, there can be four MFE development teams/domains 204: 1) MyAccount.com (shell for all MFEs), 2) Subscription MFE to create the subscription, 3) Digital fulfillment MFE (DF MFE) to generate the license for the subscription for each customer site(s), and 4) Customer MFE to accept the Tenant ID and Domain ID of customer, verify, and give back to subscription MFE.

For example, in general customers/end users configure the subscription in MyAccount. Customer/end user clicks a button to get a license key for the subscription. Customer/end user is asked to enter a “TenantID and Domain” (i.e., credentials). Once credentials are entered, customer/end user, subscription is created.

As discussed, MFE development teams/domains 204 create virtualized container shells and virtualized dependent MFEs to be used in development and testing of MFEs without relying on other teams/domains.

Continuing with the example, the MFE development team/domain 204 for the subscription works on subscription details of the MFE page, and creates a container virtualized MFE (CVMFE), if not already created/available, which includes team name (i.e., “subscription”), application name (e.g., SUB), and layout (header: top, body: center, operation: right).

Implementations provide for clicking on an UI as described above, when creating a virtual instance of the CVMFE for the MFE development team/domain 204 SUB team, in a new container. For example, a virtualized MFE container as shown in FIG. 5 is opened. The MFE development team/domain 204 SUB team can develop “subscription details MFE”, which needs inputs as OfferID, QuoteID to show the page. Details come from a catalog/database; however, the MFE can be self loading by clicking on button 502 of the container 500 of FIG. 5.

The dependent virtualized MFE can be configured as defined by the following table 5.

TABLE 5

| | | | | Suggested |
|---|---|---|---|---|
| Direction | Description | Data Type | Nature of Values | Control |
| Self | Offer ID | Text | Single Value | TextBox |
| Self | Order Number | Number | Single Value | TextBox |

Callback endpoints may be obtained/defined from a particular URL (e.g., https://myserver/SubscriptionDetails). Once callback endpoints are submitted, they can be deployed in the container 600 shown in FIG. 6. Controls can appear as “self-loading MFE parameters.” Customer/end user or another MFE development team/domain 204 can enter any “Offer ID and Order Number” and load the “Subscription Details MFE” in the virtualized MFE Container 600, avoiding the need to depend on the catalog module to start developing the MFE.

As discussed, the MFE container 600 has a button “Activate License” 602 that calls the digital fulfillment MFE or DF MFE to activate a license for an order. The button “Get Tenant” 604 calls customer/user ID MFE or Customer MFE, to capture a Tenant ID and Domain ID from an end user/customer, which are verified. Once the information is received, the “Create Subscription” button 606 creates a subscription.

Since the digital fulfillment MFE (DF MFE) and customer MFE may not be ready or available to use, dependent virtualized MFEs for the DF MF and customer MFE. As discussed, in order to activate a license, the DF MFE needs a customer ID and an order number.

As discussed above, the process for the DF MFE can be the following: 1) DF MFE will accept LAC Code and Customer Location, 2) DF MFE activates the license for the customer site, 3) DF MFE returns a License Key, a Letter Activation Code, and Customer Sites to Create Subscription. For 2) and 3) in particular, business functions (e.g. licensing business processes) are performed. When a virtualized dependent MFE is implemented, such business functions are not important. Business functions (e.g. licensing business processes) occur for digital fulfillment and generation of license, and activation for customer locations; however, the virtual dependent MFE just imitates input and output with end user/customer entering values.

Referring back to FIG. 7, a representation is shown of a digital fulfillment or DF MFE. In particular, a dependent virtualized MFE is represented by DF MFE 700. MFE development teams/domains 204 are able to use the virtualized container 400 to add a new virtual MFE, for example configure the virtual MFE as a “Licensing Virtual MFE”. Referring to table 2 above, an example is shown.

As discussed, The MFE virtualization engine 120 can use the template described in FIG. 5 and the configurations of Table 2 to create an MFE image used in continuous integration/continuous development (CI/CD) to be deployed as a dependent virtualized MFE.

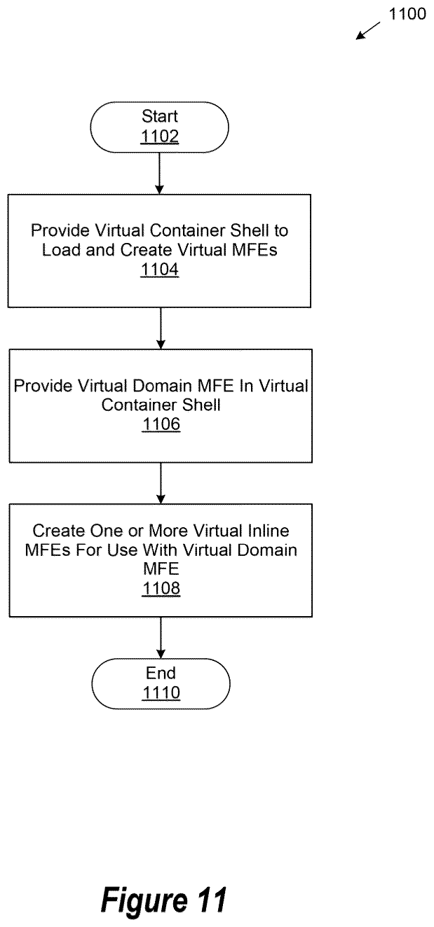

FIG. 11 shows a generalized flowchart for micro front end (MFE) virtualization. Implementations provide for the steps of process 1100 to be performed by the micro front end (MFE) virtualization engine 120. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention.

At step 1102, the process 1100 starts. At step 1104, a virtual container shell is provided. The virtual container shell is used to load and create virtual or virtualized MFEs.

At step 1106, a virtualized domain MFE in the virtual container shell is provided in the virtual container shell. The virtualized domain MFE is used to develop and test a “real” MFE that will be used by customers or end users.

At step 1108, one or more virtualized inline MFEs are created. There is downward and loopback dependency between the virtualized domain MFE and the virtualized inline MFEs, At step 516, the process 500 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for micro front end (MFE) virtualization comprising:
providing a virtual container shell to load and create virtual MFEs;
providing a virtualized domain MFE in the virtual container shell, for developing and testing an MFE for customer use; and
creating one or more virtualized inline MFEs for use with the virtualized domain MFE, wherein downward and loopback dependency is provided between the virtualized inline MFEs and virtualized domain MFE.

2. The computer-implementable method of claim 1, wherein the virtual container shell is automatically generated.

3. The computer-implementable method of claim 1, wherein the virtual container shell is manually generated.

4. The computer-implementable method of claim 1, wherein the virtual container shell provides a virtualized MFE environment for independent MFE development and testing.

5. The computer-implementable method of claim 1, wherein the virtualized domain MFE mimics end user data flow and data flow between the virtualized domain MFE and virtualized inline MFEs.

6. The computer-implementable method of claim 1, wherein the virtualized domain MFE, and the virtualized inline MFEs, are related to actual MFEs supported by independent teams or domains.

7. The computer-implementable method of claim 1, wherein virtualized inline MFEs are stored and accessible for reuse.

8. A system comprising:
a plurality of processing systems communicably coupled through a network, wherein the processing systems include non-transitory, computer-readable storage medium embodying computer program code interacting with a plurality of computer operations for micro front end (MFE) virtualization comprising:
providing a virtual container shell to load and create virtual MFEs;
providing a virtualized domain MFE in the virtual container shell, for developing and testing an MFE for customer use; and
creating one or more virtualized inline MFEs for use with the virtualized domain MFE, wherein downward and loopback dependency is provided between the virtualized inline MFEs and virtualized domain MFE.

9. The system of claim 8, wherein the virtual container shell is automatically generated.

10. The system of claim 8, wherein the virtual container shell is manually generated.

11. The system of claim 8, wherein the virtual container shell provides a virtualized MFE environment for independent MFE development and testing.

12. The system of claim 8, wherein the virtualized domain MFE mimics end user data flow and data flow between the virtualized domain MFE and virtualized inline MFEs.

13. The system of claim 8 wherein the virtualized domain MFE, and the virtualized inline MFEs, are related to actual MFEs supported by independent teams or domains.

14. The system of claim 8, wherein virtualized inline MFEs are stored and accessible for reuse.

15. A non-transitory, computer-readable storage medium embodying computer program code for micro front end (MFE) virtualization, the computer program code comprising computer executable instructions configured for:
providing a virtual container shell to load and create virtual MFEs;
providing a virtualized domain MFE in the virtual container shell, for developing and testing an MFE for customer use; and
creating one or more virtualized inline MFEs for use with the virtualized domain MFE, wherein downward and loopback dependency is provided between the virtualized inline MFEs and virtualized domain MFE.

16. The non-transitory, computer-readable storage medium of claim 15, wherein the virtual container shell is automatically generated.

17. The non-transitory, computer-readable storage medium of claim 15, wherein the virtual container shell is manually generated.

18. The non-transitory, computer-readable storage medium of claim 15, wherein the virtual container shell provides a virtualized MFE environment for independent MFE development and testing.

19. The non-transitory, computer-readable storage medium of claim 15, wherein the virtualized domain MFE mimics end user data flow and data flow between the virtualized domain MFE and virtualized inline MFEs.

20. The non-transitory, computer-readable storage medium of claim 15, wherein the virtualized domain MFE, and the virtualized inline MFEs, are related to actual MFEs supported by independent teams or domains.
